(19) United States
(12) Patent Application Publication
(10) Pub. No.: US 2019/0362737 A1
(43) Pub. Date: Nov. 28, 2019

(54) MODIFYING VOICE DATA OF A CONVERSATION TO ACHIEVE A DESIRED OUTCOME

(71) Applicant: i2x GmbH, Berlin (DE)

(72) Inventors: Christoph Feinauer, Berlin (DE); Claudio Martay, Berlin (DE); Michael Brehm, Berlin (DE)

(21) Appl. No.: 15/989,256

(22) Filed: May 25, 2018

(51) Int. Cl. G10L 21/0332; G06N 99/00; G06N 7/00; G10L 25/03; G10L 15/06; G10L 15/02

(52) U.S. Cl. CPC G10L 21/0332; G06N 99/005; G06N 7/005; G10L 2015/025; G10L 15/063; G10L 15/02; G10L 25/03

(57) ABSTRACT

A method includes using a computing platform to apply a trained supervised machine learning model to a waveform representation of a person's voice data. The model has been trained to determine a probability of the waveform representation producing a desired outcome. The method further includes using the computing platform to modify a parameter of a phonetic characteristic of the waveform representation to produce a modified waveform representation, and apply the trained model to the modified waveform representation to determine whether the modified waveform representation has a higher probability of producing the desired outcome. The waveform representation having the higher probability is outputted.

### BRIEF DESCRIPTION OF THE DRAWINGS

Computers may be used to monitor and augment human interactions for more effective communication. For instance, computer monitoring and augmentation can help teachers improve their communication skills in dealing with their students.

### BRIEF DESCRIPTION OF THE DRAWINGS

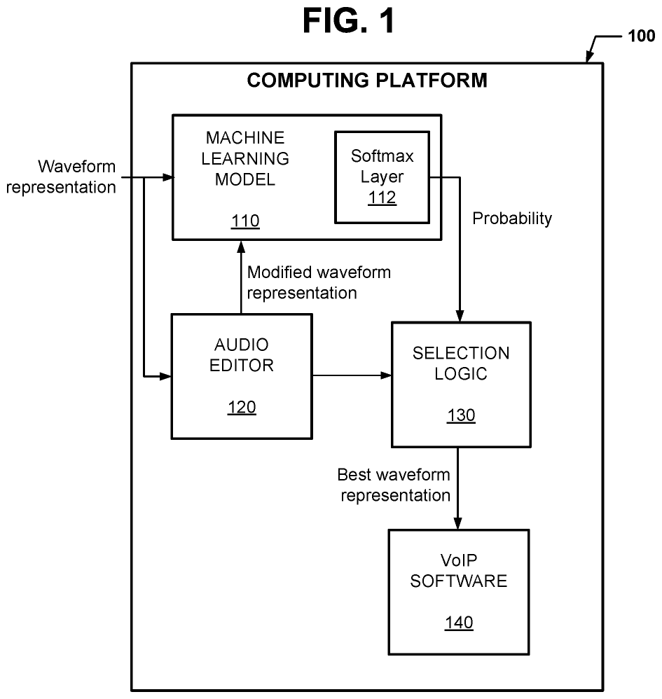

FIG. 1 is an illustration of a computing platform, including a trained machine learning model, for modifying voice data to achieve a desired outcome of a conversation.

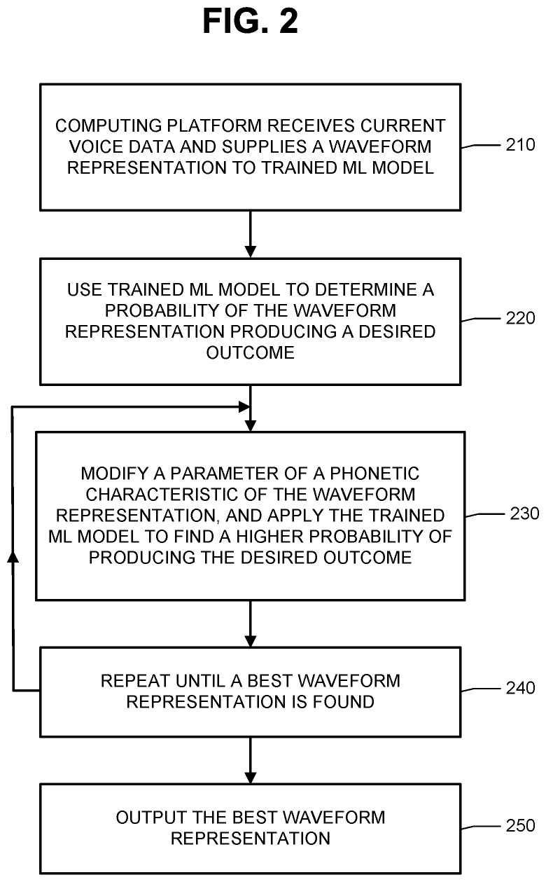

FIG. 2 is an illustration of a method of using the computing platform to modify voice data.

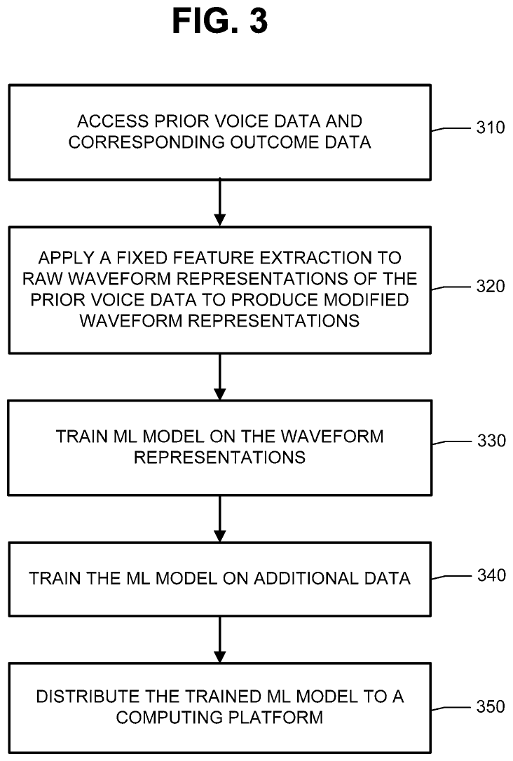

FIG. 3 is an illustration of a method of training the machine learning model of the computing platform.

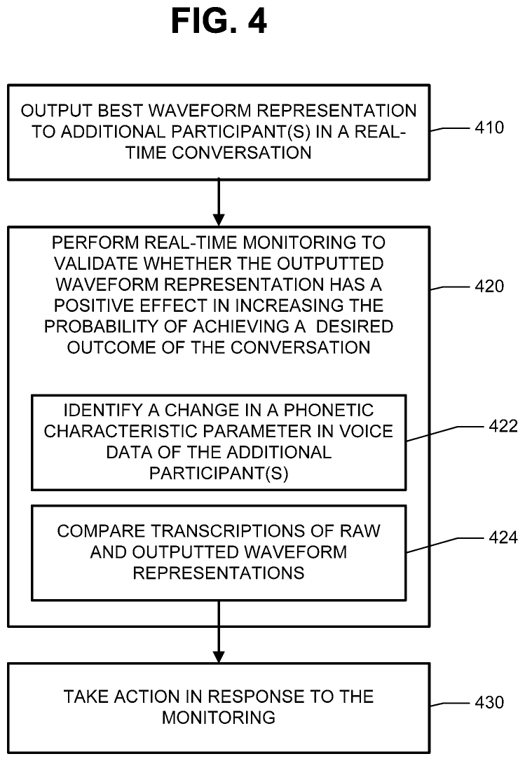

FIG. 4 is an illustration of a method of using the computing platform to conduct a real-time voice conversation.

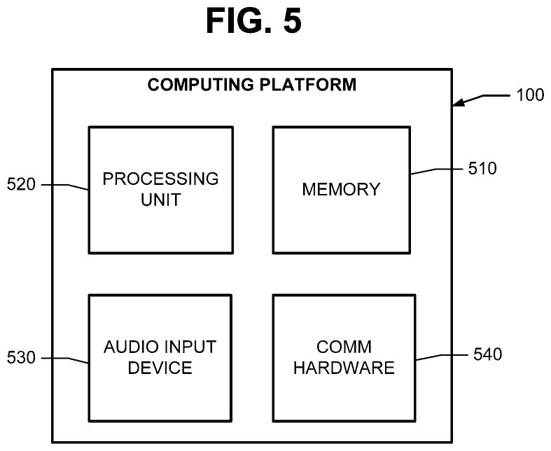

FIG. 5 is an illustration of components of the computing platform.

### DETAILED DESCRIPTION

Reference is made to FIGS. 1 and 2, which illustrate a computing platform 100 and a method of using the computing platform 100. The computing platform 100 is not limited to any particular type. Examples of the computing platform 100 range from a plurality of servers to a personal computing device such a smart phone, desktop computer, tablet, gaming console, smart watch, laptop computer, and smart headphone set.

The computing platform 100 is programmed with a trained machine learning (ML) model 110. The trained ML model 110 may be a trained supervised ML model. Examples of trained supervised ML models include, but are not limited to, a neural network, logistic regression, naive bayes, decision tree, linear regression, and support vector machine. Examples of neural networks include, but are not limited to, a feed forward network, recurrent neural network, neural network with external memory, and a network with attention mechanisms.

The trained ML model 110 processes current voice data from one or more participants in a conversation. As used herein, a conversation may range from an interactive exchange between two or more participants, to a situation where one participant records a speech and one or more other participants hear the recorded speech at a later time. An example of the former conversation is a sales meeting between a sales agent and a customer. An example of the latter conversation is a pre-recorded lecture by a teacher.

A waveform representation represents the voice data of a participant in the conversation. Therefore, voice data of a conversation may include one or more waveform representations. As used herein, a “raw” waveform representation of voice data represents speech as a plot of pressure changes over time. In such a representation, the x-axis of the plot corresponds to time, and the y-axis of the plot corresponds to amplitude.

From each raw waveform representation, phonetic characteristics can be determined. The phonetic characteristics may include acoustic phonetic characteristics. Examples of the acoustic phonetic characteristics include, but are not limited to, pitch, timbre, volume, power, duration, noise ratios, length of sounds, and filter matches.

As used herein, a parameter refers to a value or value range of a phonetic characteristic. For example, volume (a phonetic characteristic) may have a parameter value of 60 dBa or a parameter range of 55-65 dBa.

The trained ML model 110 was previously trained to determine a probability of a waveform representation producing a desired outcome of a conversation. The trained ML model 110 is a probabilistic model, which may take the form of a conditional probability model or a joint probability model. The trained ML model 110 is trained on many input-output pairs to create an inferred function that maps an input to an output. The input of each input-output pair is a waveform representation of prior voice data, and the output is corresponding outcome data. Each item of outcome data indicates whether the corresponding waveform representation produced a desired outcome.

The trained ML model 110 has a so called “softmax” layer 112 or equivalent thereof. In probability theory, an output of the softmax layer 112 can be used to represent a categorical distribution—that is, a probability distribution over different possible outcomes. Rather than simply outputting a binary indication (e.g., yes/no) of the desired outcome being achieved, the softmax layer 112 can provide a probability of the desired outcome being achieved.

FIG. 2 illustrates how the trained ML model 110 may be used to modify voice data of a conversation between a participant using the computing platform 100 (the “first participant”) and one or more other participants. At block 210, the computing platform 100 receives current voice data from the first participant and supplies a raw waveform representation to the trained ML model 110. For instance, the first participant speaks into a microphone, which supplies a waveform representation in a digital format to the corresponding to the trained ML model 110.

At block 220, the trained ML model 110 determines a probability of the waveform representation producing a desired outcome. The probability is taken from the softmax layer 112.

At block 230, a parameter of a phonetic characteristic of the waveform representation is modified to produce a modified waveform representation. The trained ML model 110 is applied to the modified waveform representation to find a probability of producing the desired outcome.

The computing platform 100 may include a digital audio editor 120 that changes the parameter of the phonetic characteristic of the waveform representation to produce the modified waveform representation. Digital audio editing software that can make the modifications in real time is commercially-available.

The functions of block 230 may be performed repeatedly until the “best” waveform representation having the highest probability is selected (block 240). For instance, a plurality of modified waveform representations having different parameters of the phonetic characteristic is created, the trained ML model 110 is applied to each modified waveform representation to determine a probability, and selection logic 130 selects the modified waveform representation having the highest probability of producing the desired outcome (the audio editor may implement the selection logic, or separate software may implement the selection logic). The highest probability may be an optimal probability, or it might be the highest probability after a fixed number of iterations, or the highest probability after a predefined time period has elapsed. For instance, the predefined time period may be the time it takes for a human to respond, as defined by psychoacoustics (e.g., 300 ms to 500 ms).

At block 250, the computing platform 100 outputs the best waveform representation. The computing platform 100 may be programmed with Voice over IP (“VoIP”) software 140, and the best waveform representation is supplied to the VoIP software 140. The VoIP software 140 sends the best waveform representation to the other participants. The VoIP software 140 may also be used to receive voice data from the other participant(s). The computing platform 100 may also include an audio output device such as speakers for playing the voice data from the other participant(s).

If the digital audio editor 120 modifies the parameters of multiple phonetic characteristics, the parameters may be changed simultaneously or sequentially. As an example of making the modifications sequentially, the parameter of a first phonetic characteristic is modified until a best waveform representation is found for the first characteristic, and then the parameter of a second phonetic characteristic is modified until a new best waveform representation is found for the second phonetic characteristic.

In the method of FIG. 2, only a single computing platform 100 is used (by the first participant) during the conversation. However, a method herein is not so limited: multiple computing platforms 100 may be used during a conversation. For example, in a virtual business meeting involving three participants, each participant uses a computing platform 100. Consequently, the waveform representations of all three participants may be modified during the virtual business meeting.

As for determining which phonetic characteristic(s) whose parameter(s) will be modified, that determination may be made before or after the ML model 110 has been trained. For instance, the phonetic characteristics may be determined prior to training by speech experts who look at prior research and conduct research to identify those phonetic characteristics that are significant in affecting the desired outcome of a conversation.

In some configurations, the computing platform 100 may also allow a user to define the phonetic characteristic(s) whose parameters are modified. For instance, the user believes that having a higher pitch is useful for a specific interaction. The computing platform 100 may display a user interface that allows a phonetic characteristic (e.g. timbre, loudness, pitch, speech rate) to be selected, and an action to be taken on (e.g., increase or decrease) the parameter of the selected phonetic characteristic.

Reference is made to FIG. 3, which illustrates a method of training an ML model. The training is performed by a computing platform, which may be the computing platform 100 of FIG. 1, or which may be a different computing platform.

At block 310, prior voice data and corresponding outcome data are accessed. The prior voice data represents a plurality of prior voice conversations between participants. A conversation may be saved in its entirety, or only portion may be saved. The prior voice data may be accessed from data storage (e.g., a local database, a digital warehouse, a cloud), streamed, a physical portable storage device, (e.g., USB drive, CD).

The voice data of each prior voice conversation may be labeled with an outcome. The outcome of the prior voice conversation may or may not be the desired outcome. For instance, a successful outcome is desired, and the outcome data indicates those prior voice conversations having successful outcomes and those prior voice conversations having unsuccessful outcomes.

At block 320, a fixed feature extraction may be applied to raw waveform representations of the prior voice data to produce a plurality of pre-processed waveform representations. A first example of a pre-processed waveform representation is a spectrogram, where the x-axis corresponds to time, and the y-axis corresponds to frequency. A second example of a pre-processed waveform representation is a mel-generalized cepstral representation, where the power spectrum of speech is represented by mel-generalized cepstral coefficients.

At block 330, the ML model is trained on the waveform representations. The waveform representations may include only the raw waveform representations, or only the pre-pre-processed waveform representations, or a combination of both the raw and pre-processed waveform representations. The training is performed on voice data corresponding to all outcomes rather than just desirable outcomes.

At block 340, the model may be trained on additional data. The additional data may include parameters of phonetic characteristics (which can be determined by the audio editor 120). Such training enables the ML model to identify patterns of phonetic characteristics in the waveform representations and correlate the patterns to the outcome data.

At block 350, the trained ML model 110 may be distributed to the computing platform 100 of FIG. 1. The computing platform 100 stores the trained ML model 110.

The ML model is trained on a large set of voice data samples. A set of samples may be unique and distinct so as to produce a trained ML model 110 that is domain-specific. Examples of domains include, but are not limited to, a field of industry, demographic group, and cultural group. However, in some instances, the voice data may be taken across multiple domains. For example, the voice data is taken across different industries (e.g., medicine or education), whereby the desired outcomes could vary greatly.

Reference is now made to FIG. 4, which illustrates a method of conducting a real time conversation between a first participant and at least one additional participant. The first participant uses the computing platform 100 of FIG. 1. Voice data of the first participant provides the waveform representation that is supplied to the trained ML model 110. Each additional participant may also use the computing platform 100 of FIG. 1.

At block 410, the computing platform 100 receives voice data from the first participant, finds a best waveform representation having the highest probability of achieving a desired outcome, and outputs the best waveform representation to the other participant(s). The best waveform representation is found according to the method of FIG. 2.

At block 420, the computing platform 100 performs real-time monitoring to validate whether the outputted waveform representation has a positive effect in increasing the probability of achieving the desired outcome. Two examples of the monitoring will now be provided.

At block 422, the monitoring includes identifying a change in a phonetic characteristic parameter in an additional participant's waveform representation. The change in the parameter may be determined by supplying a waveform representation of the additional participant's voice data to the trained ML model 110. Any parameter change would likely change the probability output of the trained ML model 110.

At block 424, the monitoring includes creating a transcription of the raw and outputted waveform representations of the first participant's voice data. A comparison of these two transcriptions can indicate whether the outputted waveform representation maintained its integrity in expressing words spoken by the first participant. Any discrepancy in the transcriptions will inform the trained ML model 110 of whether the current modifications are more or less intelligible than before the modification.

At block 430, an action may be taken in response to the monitoring. If the monitoring at block 424 indicates that the current modifications are deemed unintelligible, or if the monitoring at block 422 indicates that the current modifications do not produce the desired effect on the outcome, the modifications may be stopped. In the alternative, magnitude of the modifications may be changed.

The computing platform 100 may be used to improve the probability of achieving a desired outcome without the use of video data. For instance, the probability can be improved without having to identify an emotional state of the additional participant(s). Advantageously, there is far less data to access, far less processing to perform, and far less speculation as to the actual emotional states of the participant(s). Further, a wider variety of computing platforms may be used, including those that are audio-only.

In some implementations, a single computing platform may perform the training and use the trained ML model 100. In other implementations, different computing platforms may be used to train the ML model and use the trained ML model 110. As a first example, a first computing platform performs the training, and a second computing platform (the computing platform 100 of FIG. 1) receives and uses the trained ML model 110. As a second example, a first computing platform (e.g., a server system) performs the training, a second computing platform receives the trained ML model 110 (the computing platform 100 of FIG. 1), and a third computing platform (e.g., a personal computing device) sends raw voice data to the second computing platform. The second computing platform, which has significantly greater computational power than the third computing platform, applies the trained ML model 110 to a raw waveform representation and sends to the third computing device a best waveform representation that has the highest probability of achieving a desired outcome.

Reference is now made to FIG. 5, which illustrates an example of components of the computing platform 100. The computing platform 100 includes memory 510 and a processing unit 520 for storing and using the trained ML model 110, audio editor 120, selection logic 130, and VoIP software 140. The computing platform 100 also includes an audio input device 530 (e.g., a microphone) for receiving voice data.

The computing platform 100 further includes communications hardware 540 (e.g., a network interface card, USB drive) for receiving the trained ML model 110. For instance, the computing platform 100 could receive the trained ML model 110 over the Internet via a browser user interface extension, an installed desktop application, a dongle USB driver configured for Internet communication, a mobile phone application, etc.

Methods and computing platforms herein may be used to modify voice data in real-time or non-real time. Two examples will now be described: (1) a trained ML model 110 is used in customer relations to modify voice data of an agent who is conversing with a customer; and (2) a trained ML model 110 is used by a professor at an online educational institution to modify voice data of a lecture that will be viewed by students at a later time.

### Example 1: Customer Relations

A giant retailer maintains a staff of agents, who handle various customer relations, including customer complaints. The retailer maintains a cloud that stores data of prior customer relations conversations between customers and agents. Participants in the prior conversations may include the present agents, but could also include former agents of the retailer, and agents who are employed elsewhere. The prior conversations may be labeled with CRM labels, which indicate the outcomes of the conversations. For instance, an outcome could indicate a satisfactory resolution or an unsatisfactory resolution.

The retailer, or a third party, maintains a facility including a computing platform that receives the labeled voice data and trains an ML model on the labeled voice data. Some or all of the labeled voice data may be used to produce a trained ML model 110.

Agents of the retailer are equipped with computing platforms 100. The agents may be in a central location, or they may be dispersed at different remote locations. For instance, some agents might work at a central office, while other agents work from home. The facility makes the trained ML model 110 available to the computing platforms 100 of the agents.

The agents use their computing platforms 100 to interact with customers. The computing platforms 100 modify agents' waveform representations to increase the probability of producing positive customer interactions (e.g., successful resolutions). If an agent is about to call a customer and knows that the customer responds well to, for instance, a higher pitch or an inflection placed at the end of the word, the agent select one or more phonetic characteristics for the computing platform 100 to modify.

The computing platform 100 can also apply the trained ML model 110 to a customer's voice data. For instance, a best waveform representation of the customer's voice data can be found to produce a modified waveform representation so the agent hears a “better” customer voice. For example, a “better” customer voice might be perceived as less confrontational.

Each computing platform 100 may be characterized as performing a supervisory role with respect to an agent. The computing platform 100 can monitor the form of the agent's language. Advantageously, a supervisor isn't required to be present at each remote location. Thus, the computing platforms 100 enable the agents to work under “supervision” at remote locations.

### Example 2: Online Educational Institution

An online educational institution provides an online interface via a web browser that enables the delivery of recorded vocal content to be delivered to a plurality of remotely located students. The online educational institution stores a backlog of recorded prior lessons, and it stores feedback from those students who received the recorded educational material associated with the prior recorded lessons. Examples of the feedback include a scale of 1-10, a yes and no answer to a question, and how a student perceives the quality of their learning experience. The feedback is used to label the prior lessons, and the labeled prior lessons are used to train an ML model in a lesson specific domain.

A third party maintains an online cloud-based platform, which accesses the labeled lessons and performs the training. Resulting are custom domain-specific trained ML models 100 for determining the success probability of phonetic characteristics in delivering an education lesson in the desired domain.

Some teachers at the online institution are equipped with computing platforms 100. Those teachers make their usual recordings of lessons, use their computing platforms 100 to modify the lessons, and then upload the modified lessons via a web browser to an online interface provided by the online educational institution.

Some teachers at the online institution are not equipped with computing platforms 100. Those teachers make their usual recordings of lessons, and upload the recordings to a website associated with the online educational institution. The lessons uploaded to the website are modified with trained ML models 100.

The modified lessons may be uploaded onto the online interface via a web browser for students to access. The students, teachers, third party (voice modification supplier) and online educational institution are all remotely located.

These two examples illustrate how the computing platforms 100 enable agents to deal more successfully with customers, and teachers to be more effective in delivering educational outcomes to their students. Computing platforms 100 and methods herein are not limited to these two examples. Another example could involve health care, where a computing platform 100 is used to help a counselor talk to a patient with greater empathy. Yet another example could involve public safety, where a computing platform 100 is used to modify the voice of an official giving instructions over an emergency loudspeaker to urgently direct a crowd to safety. The computing platform 100 can modify the official's waveform representation to create a calming and authoritative perception, which would be better at getting the crowd to a safe destination.

1. A method comprising using a computing platform to:
apply a trained supervised machine learning (ML) model to a waveform representation of a person's voice data, the model having been trained to determine a probability of the waveform representation producing a desired outcome;
modify a parameter of a phonetic characteristic of the waveform representation to produce a modified waveform representation, and apply the trained model to the modified waveform representation to determine whether the modified waveform representation has a higher probability of producing the desired outcome; and
output the waveform representation having the higher probability.

2. The method of claim 1, wherein the trained ML model has a softmax layer, and wherein each probability is taken from the softmax layer.

3. The method of claim 1, wherein the trained ML model had previously been trained on various waveform representations of prior voice data and corresponding outcome data, each item of outcome data indicating whether its corresponding waveform representation produced a desired outcome.

4. The method of claim 1, wherein the modifying includes creating a plurality of additional modified waveform representations having different parameters of the phonetic characteristic, and using the trained ML model to determine a probability associated with each additional waveform representation, and wherein the outputting includes outputting a best waveform representation, which has a highest probability of producing the desired outcome.

5. The method of claim 1, wherein the phonetic characteristic whose parameter is modified is defined by a user of the computing platform.

6. The method of claim 1, wherein the trained ML model has been previously trained by:
accessing prior voice data representing a plurality of prior voice conversations and accessing outcome data indicating outcomes of the prior voice conversations;
applying a fixed feature extraction to raw waveform representations of the prior voice data to produce a plurality of pre-processed waveform representations; and
training the ML model on the pre-processed waveform representations and the outcome data.

7. The method of claim 6, wherein the model has been previously trained on a combination of both the raw and pre-processed waveform representations.

8. The method of claim 6, wherein the ML model has also been previously trained on parameters of phonetic characteristics of the raw and/or pre-processed waveform representations.

9. The method of claim 6, wherein the prior voice data is in a specific domain.

10. The method of claim 1, wherein the computing platform is used to conduct a real-time conversation between a first participant, whose voice data provides the waveform representation that is supplied to the trained ML model, and an additional participant.

11. The method of claim 10, further comprising performing monitoring to validate whether the outputted waveform representation has a positive effect in increasing the probability of achieving the desired outcome.

12. The method of claim 11, wherein the monitoring includes identifying a change in phonetic characteristics in the additional participant's voice data.

13. The method of claim 11, wherein the monitoring further includes using a transcription of the real-time conversation to verify that the outputted waveform representation maintained its integrity in expressing words.

14. A computing platform comprising:
an audio input device for generating a waveform representation of voice data;
a trained supervised machine learning (ML) model for application to the waveform representation to determine a probability of the waveform representation producing a desired outcome; and
means for repeatedly modifying a parameter of a phonetic characteristic of the waveform representation to produce modified waveform representations, and supplying the modified waveform representations to the trained ML model to find a best waveform representation, which has a highest probability of producing the desired outcome.

15. The computing platform of claim 14, wherein the trained ML model has a softmax layer, and wherein each probability is taken from the softmax layer.

16. The computing platform of claim 14, further comprising Voice over IP (VoIP) software, wherein the best waveform representation is outputted to the VoIP software.

17. A method comprising
accessing prior voice data representing a plurality of prior voice conversations and accessing outcome data indicating outcomes of the prior voice conversations;
using a first computing platform to perform training of a supervised machine learning (ML) model with various waveform representations of the prior voice data and the outcome data to generate an inference function that relates the waveform representations to probabilities of producing a desired outcome;
using a second computing platform, programmed with the ML model trained by the first computing platform, to receive current voice data of a real-time conversation, and apply the trained ML model to a participant's waveform representation of the current voice data to determine a probability of the participant's waveform representation producing a desired outcome; and
repeatedly using the second computing platform to modify a parameter of a phonetic characteristic of the participant's waveform representation to produce modified waveform representations, and apply the trained ML model to the modified waveform representations until a best waveform representation has been found; and
outputting the best waveform representation.

18. The method of claim 17, wherein the training of the ML model includes:
applying a fixed feature extraction to raw waveform representations of the prior voice data to produce a plurality of pre-processed waveform representations; and
training the ML model on the pre-processed waveform representations and the outcome data.

19. The method of claim 18, wherein the ML model is also trained on the raw waveforms representations.

20. The method of claim 19, wherein the ML model is also trained on parameters of phonetic characteristics of the raw and/or pre-processed waveform representations.
